(19) United States
(12) Patent Application Publication
(10) Pub. No.: US 2004/0242537 A1
(43) Pub. Date: Dec. 2, 2004

(54) Acetylation method of chitosan

(76) Inventors: Chen-Gum Oh, Bucheon (KR); Seung-Lim Park, Jeju (KR)

Correspondence Address: PARK & SUTTON LLP, 3255 WILSHIRE BLVD, SUITE 1110, LOS ANGELES, CA, 90010, US

(21) Appl. No.: 10/493,251

(22) PCT Filed: Aug. 9, 2002
(86) PCT No.: PCT/KR02/01517

(30) Foreign Application Priority Data
Nov. 2, 2001 (KR) 2001-68229

(51) Int. Cl. C08B 37/08

(52) U.S. Cl. 514/55; 536/20

(57) ABSTRACT

The present invention relates to a method for acetylation of chitosan, which enables acetylated chitosan of a desired acetylation degree to be produced. The method comprises producing a crude reactant solution using chitosan or chitosan oligosaccharide produced by decomposition and deacetylation of chitin as a raw material; and passing the crude reactant solution through an inline mixer while sequentially continuously a pH-adjusting agent and acetic acid anhydride into the inline mixer, so that the crude reactant solution is subjected to acetylation reaction.

### TECHNICAL FIELD

The present invention relates to a method for acetylation of chitosan, which enables production acetylate of a desired acetylation degree. This method comprises producing a crude reactant solution using chitosan or chitosan oligosaccharide produced by decomposition and deacetylation of chitin, as a raw material; and passing the crude reactant solution through an inline mixer while continuously introducing a pH-adjusting agent and acetic acid anhydride in sequence into the inline mixer so as to subject the crude reactant solution to acetylation.

### BACKGROUND ART

Chitin is polysaccharide where N-acetyl-D-glucosamine monomers are β-1,4-poly-linked.

To naturally occurring chitin, D-glucosamine where an acetyl group of N-acetyl-D-glucosamine was removed is partially poly-linked.

Where chitin is added with an alkaline solution and heated, the acetyl group of N-acetyl-D-glucosamine, that is a monomer for forming chitin, is removed, thereby producing D-glucosamine.

When a content of D-glucosamine, which is produced by deacetylating chitin with alkali so as to remove the acetyl group from N-acetyl-D-glucosamine, is more than 70%, it is called “chitosan” (see, food additive process notified by Korea Food and Drug Administration).

In other words, chitosan is polysaccharide whose D-glucosamine content is more than 70% and N-acetyl-D-glucosamine content is less than 30% (see, FIG. 6).

When chitosan is hydrolyzed, two to nine poly-linked chitosan oligosaccharides containing D-glucosamine and N-acetyl-D-glucosamine are produced.

The present invention relates to an acetylation method in which chitosan or chitosan oligosaccharide produced by decomposition and deacetylation of chitin as described above, is used as a starting material, and acetylated in an inline mixer using acetic acid anhydride with adjustment of pH.

Chitosan has properties in that it is easily dissolved in univalent acids, including dilute hydrochloric acid, acetic acid or lactic acid, and easily dissolved in acids having a divalent or more ion, including sulfuric acid, phosphoric acid, malic acid, succinic acid, citric acid, fumaric acid or the like, upon heating. For this reason, it is used in various industrial applications as compared to chitin.

Since chitosan is cationic polyelectrolyte, it started to be industrially applied as a cohesive agent in wastewater treatment. Also, by studies conducted on its functionality, it is applied in fields of drugs, foods, cosmetics, agriculture and the like. Furthermore, with development of chitosan oligosaccharide of low molecular weight, application field of chitosan shows a tendency to expand and subdivide into an immune-enhancing agent, a cholesterol-lowering agent, a natural antibiotic, a diabetes-treating agent and the like.

However, because of its strong cohesive power and adsorption power, chitosan shows highly unstable properties when it contains various substances. Also, it is insoluble in the presence of alkali so that it is difficult to be applied.

In drug application, chitin does not cause in vivo hyperimmune response and is somewhat digested and absorbed by in vivo enzymes. However, it is known that chitosan has an anxiety of harmful effects, such as hyperimmune response, and is not digested and unabsorbed in vivo.

In order to solve such problems of chitosan and to endow chitosan with various functionalities, molecular weight of chitosan is adjusted, various derivatives which are known to be more stable, including carboxymethylchitin and carboxymethylchitosan, are developed. However, another method is required which is inexpensive in production cost and can solve these problems.

Meanwhile, Japanese Patent Laid-Open Publication No. Pyung 4-39301 discloses a method for producing deacetylated chitin of a deacetylation degree of 40 to 60%, from chitin. However, this method is disadvantageous in that purity of the produced chitin is inferior to chitosan having a deacetylation degree of more than 70%. Moreover, this method is disadvantageous in that it is not easy to obtain a uniform product according to alkali concentration, temperature control and treatment time, and the vast facility and time are required for industrial application.

Furthermore, Japanese Patent Laid-Open Publication No. Pyung 7-90005 discloses a method for producing acetylated chitosan of a deacetylation degree of more than 95% using acetic acid anhydride. However, since a method of adding the acetic acid anhydride is not concretely described, a degree of acetylation significantly varies depending on the addition method. Also, the acetic acid anhydride is added at the amount of more than 5 times a stoichiometric amount of acetic acid anhydride required for acetylation, so that the resulting product hardly shows reproducibility.

According to results of experiments conducted by the present inventor, the resulting products exhibited a significant difference in deacetylation degree, and large amounts of insoluble precipitates occurred during storage. Also, it was difficult to obtain acetylated chitosan of a uniform distribution by the above methods.

Japanese Patent Laid-Open Publication No. Pyung 8-283306 discloses a method for producing partially deacetylated chitin of a deacetylation degree of about 30% using hydrochloric acid and the like, from chitin powder via an aqueous alkaline solution of chitin. However, this method is unsuitable for application in industrial production in view of a temperature condition or treatment time, and process conditions for mass production are not easy.

Japanese Patent Laid-Open Publication No. Pyung 10-72502 discloses a method for producing acetylated chitosan of a deacetylation degree of about 50% using acetic acid anhydride. However, in this method, the acetic acid anhydride is added at the amount of more than 5 times its stoichiometric amount, and using an organic solvent at large amount for control of acetylation is unreasonable in an industrial production process.

Furthermore, the present inventors have examined the above prior method. As a result, a difference of more than 2% in concentration and molecular weight of chitosan was shown. In addition, it was not easy to obtain a desired result depending on whether treatment with alkali is carried out or not, and there was no reproducibility.

Japanese Patent Laid-Open Publication No. Pyung 11-5803 discloses a method for producing partially deacetylated chitin from chitin of high purity. However, in this method, a process of the prior art is utilized and an aging time is more than 15 hours, so that it is unsuitable for mass production. Also, this method has another problem in that it is not easy to obtain chitin of high purity as a starting material.

### DISCLOSURE OF INVENTION

It is therefore an object of the present invention to provide a method for acetylating chitosan or chitosan oligosaccharide produced by decomposition and deacetylation of chitin, which allows a acetylation process to be simplified and enables the amount of use of acetic acid anhydride as a reactant to be reduced, and which can be applied even in acetylation of chitosan of high concentration.

The present invention relates to a method for acetylation of chitosan, which enables production of acetylated chitosan of a desired acetylation degree, and comprises producing a crude reactant solution using chitosan or chitosan oligosaccharide produced by decomposition and deacetylation of chitin as a raw material; and passing the crude reactant solution through an inline mixer while continuously a pH-adjusting agent and acetic acid anhydride in sequence into the inline mixer such that the crude reactant solution is subjected to acetylation reaction.

The method for acetylation of chitosan according to the present invention comprises: providing a raw material consisting of chitosan or chitosan oligosaccharide produced by decomposition and deacetylation of chitin; dissolving the raw material in acids so as to produce a crude reactant solution; introducing the crude reactant solution into a first tank; continuously introducing the crude reactant solution into an inline mixer whose internal temperature is maintained at a desired temperature or below, and at the same time, first continuously introducing an alkaline solution as a pH-adjusting agent into the inline mixer and then introducing acetic acid anhydride as an acetylating agent into the inline mixer, wherein a feed rate of the respective reactants is adjusted so that the reactant solution is reacted while it is maintained at a pH of 6.0 to 8.0; transferring the resulting reactant solution to a second tank; stirring the reactant solution in the second tank for. 1 to 1.5 hours; removing salts remaining in the reactant solution; and drying the reactant solution, thereby producing an acetylated powder.

Furthermore, if a desired acetylation degree is high, the method of the present invention further comprises second acetylating the first acetylated reactant solution.

Inorganic or organic acids can be used to dissolve chitosan. However, when the inorganic acids are used, the amount of use of acetic acid anhydride as an acetylating agent shows a tendency to increase by more than 20% as compared to in the case where the organic acid is used. For this reason, it is preferred to use the organic acids.

The organic acids are preferably used at the minimum amount in order to reduce an alkali amount required for adjustment of pH.

Where univalent organic acids, including form acid, benzoic acid, acetic acid and lactic acid, are used, chitosan is dissolved at room temperature or by heating. Where divalent organic acids, including citric acid, malic acid, fumaric acid and succinic acid, are used, chitosan is dissolved by heating. The dissolved chitosan is used as a crude solution for acetylation after filtration of insoluble substances.

Where a degree of deacetylation of chitosan is less than 95%, 5% of acetyl groups are present in a local and uniform state, so that they are contributed to reduce stability after acetylation. Thus, concentration of the organic acids is determined in such a manner that pH of the chitosan solution is not lowered to less than 5.0. At this concentration of the organic acids, chitosan is dissolved, and insoluble substances are filtered out.

The present inventors have conducted examination on various factors which have an effect on acetylation, and consequently have found that pH of the reactant solution acts as an important factor in reaction of chitosan with acetic acid anhydride.

Where chitosan and acetic acid anhydride were reacted while the reactant solution was maintained at a pH of 6.0 to 8.0, a loss of acetic acid anhydride was minimized so that acetylation reaction occurred in a manner selective to amino groups at a concentration of acetic acid anhydride close to a theoretical value.

Furthermore, even when concentration of chitosan or chitosan oligosaccharide was more than 10%, normal acetylation occurred when pH of the reactant solution was maintained at 6.0 to 8.0.

Meanwhile, when the pH-adjusting agent and the acetylating agent are added, temperature rising caused by exothermic reaction occurs. For this reason, initial reaction temperature is preferably adjusted to less than 20° C.

When reaction temperature increases to more than 30° C., the acetylation reaction is accelerated so that local overreaction can occur according to a gradual increase in viscosity and concentration of chitosan. Thus, temperature of the reactant solution is adjusted to less than 30° C.

Where pH of the reactant solution is adjusted, the acetylation reaction is completely terminated in one hour at a reaction condition of less than 30° C.

In order to produce chitosan having a uniform acetylation distribution, the reaction temperature is preferably lowered according to an increase in chitosan concentration.

In the present invention, two tanks and one inline mixer are used.

For transfer of the crude reactant solution, a nono pump or positive displacement pump is used which has a transfer capacity of 30 liter/minute and a low heat generation.

As the pH-adjusting agent, a sodium hydroxide or potassium hydroxide solution having a concentration of less than 50% (w/w) is used. Where concentration of the reactant solution is less than 5% (w/w), the pH-adjusting agent is preferably used at a concentration of more than 30% (w/w). Where concentration of the reactant solution is more than 5% (w/w), the pH-adjusting agent is preferably used at a concentration of less than 30% (w/w).

Meanwhile, in order to minimize the amount of use of acetic acid anhydride, it is preferred to adjust pH of the reactant solution to 6.5-7.0.

The crude reactant solution which is the chitosan solution in the first tank is transferred to the inline mixer at a desired flow rate. During this transfer, sodium hydroxide or potassium hydroxide of a concentration of 10 to 50% (w/v) as the pH-adjusting agent is continuously fed to the inline mixer, and acetic acid anhydride of a purity of more than 90% as the acetylating agent is continuously fed to the inline mixer. The resulting reactant solution is transferred to the second tank.

As acetic acid anhydride that is the acetylating agent, a diluted liquid of acetic acid anhydride may be used as it is. Acetic acid anhydride of 100% purity per 10% acetylation degree based on a deacetylation degree of 100% of chitosan is introduced into the inline mixer at a desired rate in such a manner that acetic acid anhydride has a concentration of 3.0 to 4.0% (w/w) relative to the crude reactant solution.

In the reaction time required for industrial production, treating the crude reactant solution of 1,000 kg at a flow rate of 30 liter/minutes requires a time of about 30 to 40 minutes.

Where concentration of chitosan is more than 3% or chitosan is acetylated to an acetylation degree of 20 to 25% or more, it is preferred that the flow rate is increased by more than 5% per 1% acetylation degree so as to obtain uniform results of one time acetylation reaction, or the acetylation reaction is carried out twice or more.

However, in the case of chitosan oligosaccharide having low viscosity, one time-acetylation rate does not need to be limited in 100% acetylation.

After completion of the acetylation reaction, the crude reactant solution is stirred for more than one hour while it is stabilized. Then, it is passed through an electro-dialyzer equipped with a cation exchange membrane of a molecular weight of less than 300 daltons and an anion exchange membrane, so as to be desalted. Next, it is dried with a spray dryer to give acetylated chitosan.

In the case of chitosan oligosaccharide having a low polymerization degree, a desired acetylation degree could be obtained using the same condition as the chitosan reaction even at a concentration of more than 20%.

In order to remove salts produced during the acetylation reaction, a desalting process is carried out.

In the prior art, precipitation, washing and drying processes are carried out using organic solvents, such as alcohol. However, in order to increase desalting efficiency in the case where concentration of the raw materials is high, solvents of the amount corresponding to several ten times the amount of the crude solution must be used. This causes treatment and cost problems for waste organic solvents.

Moreover, in the case of partially acetylated chitosan or low molecular weight chitosan, such as chitosan oligosaccharide having a low polymerization degree, it is soluble or colloidal in organic solvents and thus the treating method of organic solvents is not industrially preferred.

In the present invention, ion exchange membranes of a molecular weight of 100 or 300 daltons which enable only ionic salts to be desalted were selected for efficient desalting and electro-dialysis was carried out using the selected membranes. As a result, a desalting efficiency of more than 95% could be obtained for every reaction products.

The electro-dialyzer is mainly used as a desalting device for the production of salt and serves to produce purified salt by desalting only salt components in seawater containing various organic substances. However, in the present invention, the salt purification principle of the electro-dialyzer is employed in opposition in order to remove impure salt in the reactant solution.

The deacetylation degree of chitosan produced according to the present invention was measured according to a colloid titration method described in a test method for food additive process notified by Korea Food and Drug Administration.

### BRIEF DESCRIPTION OF THE DRAWINGS

FIG. 1 is a flowchart showing acetylation of chitosan according to the present invention.

FIG. 2 is a drawing showing the order of introduction of reactant solutions into an inline mixer.

FIG. 3 is graphs showing solubilities of chitosan and acetylated chitosan of the present invention according to ethyl alcohol concentration.

FIG. 4 is graphs showing solubilities in aqueous solution of chitosan and acetylated chitosan of the present invention according to pH.

FIG. 5 is graphs showing a change in deacetylation degree according to the amount of use of acetic acid anhydride.

FIG. 6 shows structures of D-glucosamine and N-acetyl-D-glucosamine and a structure of chitosan which is polysaccharide containing D-glucosamine and N-acetyl-D-glucosamine as polymerization units.

### BEST MODE FOR CARRYING OUT THE INVENTION

The present invention will hereinafter be described in further detail by examples. It should however be borne in mind that the present invention is not limited to or by the examples.

### EXAMPLE 1

### Acetylation of Chitosan Using Acetic Acid Solution

100 kg of chitosan having a viscosity of 15 cps at a 1% chitosan solution and a deacetylation degree of 90% was provided.

100 kg of chitosan was uniformly dissolved in 2,000 kg of a 1.5% solution produced by dilution of acetic acid (98%) in water.

Insoluble substances were filtered out while temperature of the solution was lowered to 20° C. using a heat exchanger, thereby producing an acetic acid solution of chitosan (chitosan concentration: 5% (w/v)).

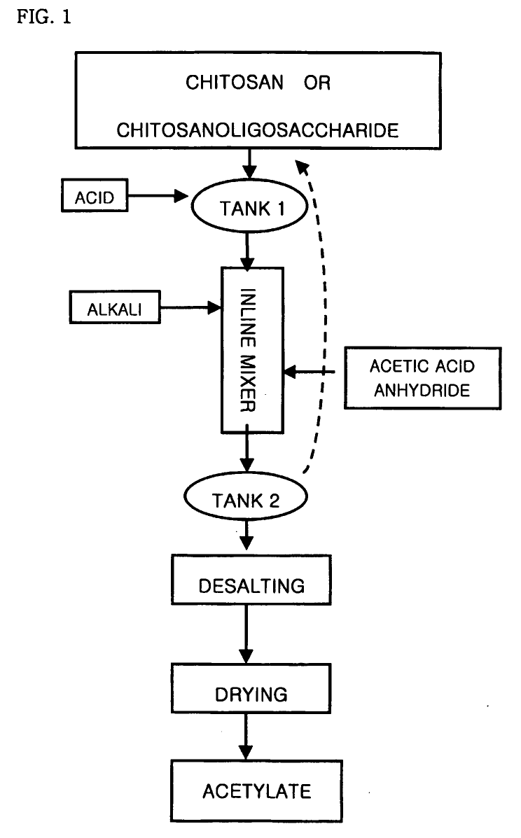

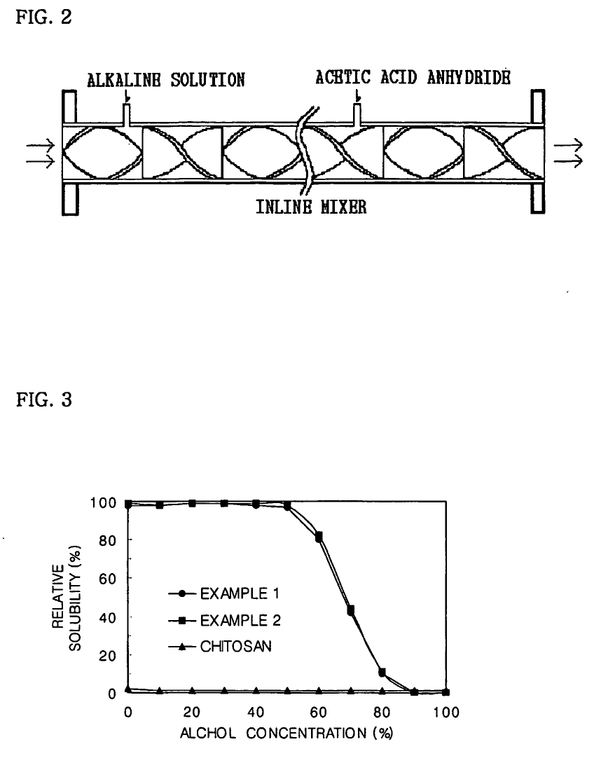

As shown in FIGS. 1 and 2, a crude reactant solution that is the acetic acid solution of chitosan in a first tank was passed through an inline mixer at a flow rate of 30 liter/minute, while a 30% (w/w) potassium hydroxide solution was continuously introduced into the inline mixer at a flow rate of 345 g/min and acetic acid anhydride (95%) was then continuously introduced at a flow rate 105 g/min.

At this time, the amount of addition of potassium hydroxide introduced was adjusted in such a manner that a uniform mixture of the acetic acid solution of chitosan, the potassium hydroxide solution and the acetic acid anhydride is maintained at a pH of 6.5.

After passage through the inline mixer, the reactant solution in a second tank was stirred for one hour.

This reactant solution was measured for a deacetylation degree of chitosan. Results show a deacetylation degree of 69.4%, indicating that acetylation of 20.6% occurred.

This reactant solution was passed through the inline mixer again while it was second subjected to acetylation in the same manner as described above.

After passage through the inline mixer, the reactant solution in the second tank was stirred for one hour.

Thereafter, salts remaining in the reactant solution were removed using an electro-dialyzer until conductivity reached zero.

Next, the resulting solution was spray-dried so as to give 107 g of the twice-acetylated chitosan powder.

The twice-acetylated chitosan powder was measured for its deacetylation degree. Results show a deacetylation degree of 49.1%, indicating that additional acetylation of 20.3% further occurred relative to the one time-acetylated chitosan.

### EXAMPLE 2

### Acetylation of Chitosan Using Lactic Acid Solution

This example was carried out in the same manner as described in Example 1 except that a 2.5% solution produced by dilution of lactic acid (90%) in water was used instead of acetic acid in order to dissolve chitosan of a deacetylation degree of 90%.

It was found that, at the first acetylation step, acetylation of 20.0% occurred, and at the second acetylation step, additional acetylation of 19.7% further occurred.

From the results of Examples 1 and 2, it was found that there was little or no difference in acetylation according to the kind of an organic acid as a solvent for chitosan.

### TEST EXAMPLE 1

### Measurement of Solubility According to Concentration of Ethyl Alcohol

Chitosan of a deacetylation degree of 90%, the twice-acetylated chitosan produced in Example 1, and the twice-acetylated chitosan produced in Example 2, were measured for their solubilities in ethyl alcohol. Results are shown in FIG. 3.

As shown in FIG. 3, the chitosan of a deacetylation degree of 90% was not mostly dissolved.

The acetylated chitosan produced in Examples 1 and 2 were mostly dissolved at an ethyl alcohol concentration of less than 50%. They exhibited a decrease in their solubility as alcohol concentration increases to more than 50%, and then were not mostly dissolved at an alcohol concentration of more than 90%.

### TEST EXAMPLE 2

### Measurement of Solubility According to pH

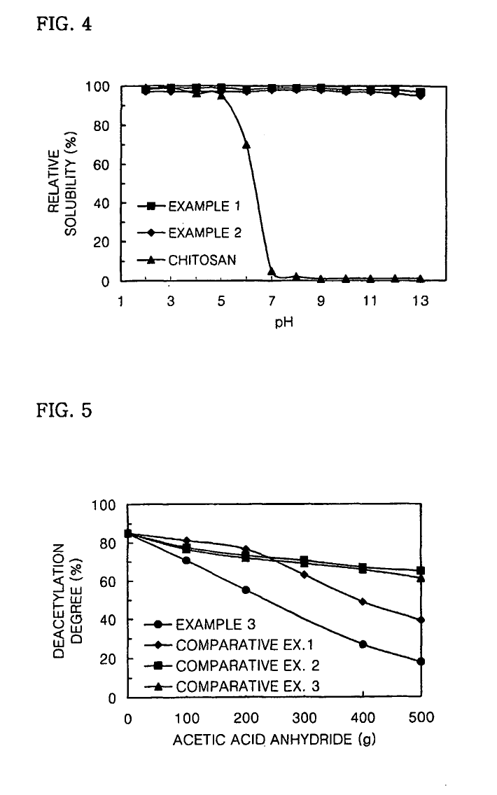

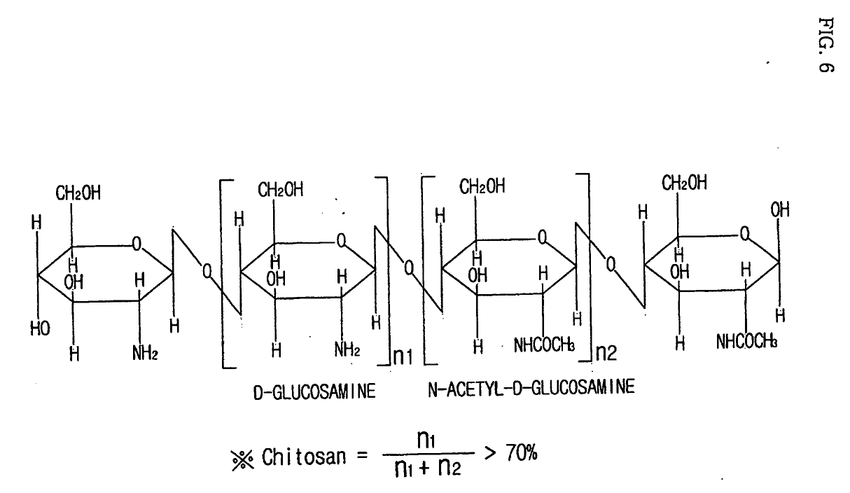

Chitosan of a deacetylation degree of 90%, the twice-acetylated chitosan produced in Example 1, and the twice-acetylated chitosan produced in Example 2, were measured for their solubilities in ethyl alcohol. Results are shown in FIG. 4.

As shown in FIG. 4, the chitosan of a deacetylation degree of 90% was mostly dissolved at an acidic pH region of less than 7. However, it exhibited a rapid decrease in solubility in the vicinity of pH 7 and then was not mostly dissolved at a pH region of more than 7.

The twice-acetylated chitosan produced in Examples 1 and 2 were mostly dissolved at all pH regions.

Moreover, the twice-acetylated chitosan produced in Examples 1 and 2 exhibited no cohesion and precipitation phenomena even after they were subjected to heat treatment at all pH regions.

### EXAMPLE 3

### Acetylation at Varying Usage of Acetic Acid Anhydride

In order to observe a change in acetylation degree according to an increase and decrease in usage of acetic acid anhydride in acetylating deacetylated chitosan, the following procedures were carried out.

2 kg of a 1% chitosan solution having a viscosity of 15 cps and a deacetylation degree of 85% was uniformly dissolved in 100 kg of a 1%(w/w) solution produced by dilution of lactic acid (90%) in water.

Insoluble substances were filtered out to produce a lactic acid solution of chitosan which was then introduced into a first tank.

The lactic acid solution of chitosan was fed to an inline mixer at a flow rate of 25 I/min. At this time, a temperature within the inline mixer was maintained at less than 30° C., and pH of the reactant solution was adjusted to the range of 6.7-7.0 with a 50%(w/w) sodium hydroxide solution. Also, 0 g, 100 g, 200 g, 500 g, 600 g, 700 g and 800 g of acetic acid anhydrides were fed to the inline mixer at a flow rate of 25 g/min, respectively, thereby acetylating chitosan.

After passage through the inline mixer, the reactant solution in the second tank was stirred for one hour.

Then, salts remaining in the reactant solution were removed using an electro-dialyzer until conductivity reached zero.

Next, the resultant solution was spray-dried to give an acetylated chitosan powder.

The respective acetylated chitosans were measured for their deacetylation degree. Results are shown in Table 1 and FIG. 5 with results of Comparative Examples 1-3.

As shown in Table 1 and FIG. 5, since the deacetylation degree of acetylated chitosan was reduced in proportion to the amount of use of acetic acid anhydride, the acetylation degree of acetylated chitosan was increased in proportion to the amount of use of acetic acid anhydride.

TABLE 1
Deacetylation degree according to amount of use of acetic acid
anhydride

| | | | Comparative | | Comparative | | Comparative | |
|---|---|---|---|---|---|---|---|---|
| | Example 3 | | Example 1 | | Example 2 | | Example 3 | |
| Chitosan | 2 | | 2 | | 2 | | 2 | |
| Reactant | 2 | | 2 | | 2 | | 2 | |
| concentration | | | | | | | | |
| Amount of use | | | | | | | | |
| of Acetic acid | | | | | | | | |
| anhydride (g) | pH¹ | D(%) | PH | D(%) | pH | D(%) | pH | D(%) |
| 0 | 5.1 | 85.0 | 12.5 | 85.0 | 5.1 | 85.0 | 5.1 | 85.0 |
| 100 | 6.8 | 70.6 | 7.6 | 83.4 | 7.0 | 80.1 | 4.0 | 82.1 |
| 200 | 6.9 | 55.0 | 6.9 | 76.5 | 7.0 | 74.6 | 3.9 | 76.7 |
| 300 | 6.9 | 40.2 | 6.6 | 68.4 | 7.0 | 71.5 | 3.8 | 72.5 |
| 400 | 6.9 | 26.8 | 6.4 | 61.2 | 7.0 | 65.7 | 3.7 | 67.9 |
| 500 | 6.8 | 17.8 | 5.9 | 53.0 | 7.0 | 62.4 | 3.6 | 63.1 |
| 600 | 6.7 | 8.7 | 5.1 | 47.8 | 7.0 | 59.3 | 3.4 | 58.5 |
| 700 | 6.6 | 0.5 | 4.3 | 43.5 | 7.0 | 57.0 | 3.3 | 53.7 |
| 800 | 6.6 | 0 | 3.9 | 38.2 | 7.0 | 54.5 | 3.2 | 49.3 |

1: pH after reaction
2: Deacetylation degree

### COMPARATIVE EXAMPLE 1

### Acetylation Using Homomixer

An experiment on acetylation of chitosan was carried out in a single tank using a homomixer.

2 kg having a viscosity of 15 cps at a 1% chitosan solution and a deacetylation degree of 85% was uniformly dissolved in 100 kg of a 1% (w/w) solution produced by dilution of lactic acid (90%) in water.

Insoluble substances were filtered out to produce a lactic acid solution of chitosan.

The lactic acid solution of chitosan was introduced into a homomixer, and a 50% (w/w) sodium hydroxide solution was added at the amount of 1.0%(w/w) relative to the reactant solution so that it was made colloidal.

The reactant solution was stirred at 12,000 rpm while it was maintained at less than 30° C. At this time, acetic acid anhydrides (95%) were added slowly at a desired flow rate. In this case, the respective acetic acid anhydrides were added at the amount of 100 g, 200 g, 300 g, 400 g, 500 g, 600 g, 700 g and 800 g, respectively.

After stirring, the reactant solution was stabilized for one hour.

Then, salts remaining in the reactant solution were removed using an electro-dialyzer until conductivity reached zero.

Next, the resulting solution was spray-dried to give acetylated chitosan powder.

The respective acetylated chitosans were measured for their deacetylation degree. Results are shown in Table 1 and FIG. 5 with results of Example 3 and Comparative Examples 2 and 3.

As shown in Table 1, the results of acetylation of chitosan in the single tank using the homomixer showed a very low acetylation degree as compared to Example 3.

### COMPARATIVE EXAMPLE 2

### Acetylation Where Acetic Acid Anhydride is First Added

As described in Japanese Laid-Open Publication No. Pyung 7-90005, acetic acid anhydride (95%) was first added and stabilized for 30 minutes. Then, the reactant solution was treated in the same manner as described in Example 1 except that it was neutralized with a 10%(w/v) potassium hydroxide solution. Results are shown in FIG. 1 and Table 1.

As shown in Table 1, the results of acetylation with first addition of acetic acid anhydride indicated a very low acetylation degree as compared to Example 3.

### COMPARATIVE EXAMPLE 3

### Acetylation with No Alkali Treatment

As described Example 5 showing the best excellent results in Japanese Laid-Open Publication No. Pyung 10-72502, the procedure of Comparative Example 1 was repeated except that acetic acid anhydride was 9.2-fold diluted and added at a flow rate of 80 mMol/min, and alkali treatment was not carried out.

As shown in Table 1, results of acetylation with no alkali treatment showed a very low acetylation degree as compared to Example 3.

### EXAMPLE 4

### Acetylation of Chitosan Oligosaccharide

Chitosan of a deaetylation degree of 90% was provided.

100 kg of chitosan was uniformly dissolved in 1,000 kg of a 3.0% acetic acid solution produced by dilution of acetic acid (98%) in water.

EC 3.2.1 132 50,000 unit-chitosan-N-acetyl-glucosaminohydrolase, a chitosanase commercially available from Sigma Co. was added and chitosan was decomposed for 10 hours.

Insoluble substances were filtered out while the enzyme was inactivated at 90° C. using a heat exchanger.

Temperature of the solution was lowered to 20° C. using a heat exchanger to give a chitosan oligosaccharide solution (chitosan oligosaccharide concentration: 10% (w/w)) to be used as a crude reactant solution.

As shown in FIGS. 1 and 2, the undiluted reactant solution of chitosan oligosaccharide in the first tank was passed through the inline mixer at a flow rate of 30 l/min to the second tank. At this time, a 50%(w/v) sodium hydroxide solution was first continuously introduced into the inline mixer at a flow rate of 280 g/min, and acetic acid anhydride (95%) was then continuously introduced into the inline mixer at a flow rate of 300 g/min.

In this case, the amount of sodium hydroxide introduced into the inline mixer was adjusted in such a manner that a uniform mixture of the crude reactant solution of chitosan oligosaccharide, the sodium hydroxide solution and the acetic acid anhydride is a pH of 6.8.

After passage through the inline mixer, the reactant solution in the second tank was stirred for one hour.

This reactant solution was transferred to the first tank and passed through the inline mixer again while it was acetylated in the same manner as described above so as to produce a second reactant solution. The second reactant solution was transferred to the first tank and then third acetylated in the same manner.

The third reactant solution was desalted and dried to give chitin oligosaccharide that is the acetylated chitosan oligosaccharide.

Results of measurement for an acetylation degree of the produced chitin oligosaccharide showed an acetylation degree of 100%.

### INDUSTRIAL APPLICABILITY

According to the present invention, the method for acetylating chitosan is provided which enables the amount of use of acetic acid anhydride to be reduced so that production cost can be reduced. Also, according to the method of the present invention, the amount of use of acetic acid can be adjusted so that acetylated chitosan or chitin oligosaccharide of a desired acetylatation can be obtained.

What is claimed is:

1. A method for acetylation of chitosan comprising:
providing a raw material consisting of chitosan or chitosan oligosaccharide produced by decomposition and deacetylation of chitin;
dissolving the raw material in acids so as to produce a crude reactant solution;
introducing the crude reactant solution into a first tank;
continuously introducing the crude reactant solution into an inline mixer whose internal temperature is maintained at a desired temperature or below, and at the same time, first continuously introducing an alkaline solution as a pH-adjusting agent into the inline mixer and then introducing acetic acid anhydride as an acetylating agent into the inline mixer, wherein a feed rate of the respective reactants is adjusted so that the reactant solution is reacted while it is maintained at a pH of 6.0 to 8.0;
transferring the reactant solution to a second tank;
stirring the reactant solution in the second tank for 1 to 1.5 hours;
removing salts remaining in the reactant solution; and
drying the reactant solution, thereby producing an acetylated powder.

2. The method of claim 1, in which the acids used to dissolve the chitosan are organic acids.

3. The method of claim 1, in which the desired internal temperature of the inline mixer is below 30° C.

4. The method of claim 1, in which pH of the reactant solution is in the range of 6.5 to 7.0.

5. The method of claim 1, in which the remaining salts are removed using an electro-dialyzer.

6. An acetylate produced according to the method of claim 1.

7. A method for acetylation of chitosan comprising:
providing a raw material consisting of chitosan or chitosan oligosaccharide produced by decomposition and deacetylation of chitin;
dissolving the raw material in acids so as to produce a crude reactant solution;
introducing the crude reactant solution into a first tank;
continuously introducing the crude reactant solution into an inline mixer whose internal temperature is maintained at a desired temperature or below, and at the same time, first continuously introducing an alkaline solution as a pH-adjusting agent into the inline mixer and then introducing acetic acid anhydride as an acetylating agent into the inline mixer, wherein a feed rate of the respective reactants is adjusted so that the reactant solution is reacted while it is maintained at a pH of 6.0 to 8.0;
transferring the reactant solution to a second tank;
stirring the reactant solution in the second tank for 1 to 1.5 hours so as to produce a first acetylated reactant solution;
transferring the first acetylated reactant solution to the first tank;
continuously introducing the first acetylated reactant solution into an inline mixer whose internal temperature is maintained at 30° C. or below, and at the same time, first continuously introducing the alkaline solution into the inline mixer and then introducing the acetic acid anhydride into the inline mixer, wherein a feed rate of the respective reactants is adjusted so that the reactant solution is second reacted while it is maintained at a pH of 6.0 to 8.0;
transferring the second reactant solution to the second tank;
stirring the second reactant solution for 1 to 1.5 hours in the second tank;
removing salts remaining in the second reactant solution using an electro-dialyzer; and
drying the desalted reactant solution, thereby producing an acetylated powder.

8. An acetylate produced according to the method of claim 7.

9. A method for acetylation of chitosan comprising:
providing a raw material consisting of chitosan or chitosan oligosaccharide produced by decomposition and deacetylation of chitin;
dissolving the raw material in acids so as to produce a crude reactant solution;
introducing the crude reactant solution into a first tank;
continuously introducing the crude reactant solution into an inline mixer whose internal temperature is maintained at a desired temperature or below, and at the same time, first continuously introducing an alkaline solution as a pH-adjusting agent into the inline mixer and then introducing acetic acid anhydride as an acetylating agent into the inline mixer, wherein a feed rate of the respective reactants is adjusted so that the reactant solution is reacted while it is maintained at a pH of 6.0 to 8.0;
transferring the reactant solution to a second tank;
stirring the reactant solution in the second tank for 1 to 1.5 hours; and
drying the reactant solution, thereby producing an acetylated powder.
